(19) United States
(12) Patent Application Publication
(10) Pub. No.: US 2026/0347199 A1
(43) Pub. Date: Nov. 5, 2026

(54) PROCESS AND PLANT FOR PRODUCING AMMONIA

(71) Applicant: Linde GmbH, Pullach (DE)

(72) Inventors: Florian ETTNER, Pullach (DE); Martin VINCENTELLI, Pullach (DE)

(21) Appl. No.: 19/108,043

(22) PCT Filed: Jul. 14, 2023
(86) PCT No.: PCT/EP2023/025327

§ 371 Date: Feb. 28, 2025

(30) Foreign Application Priority Data
Sep. 2, 2022 (EP) 22020424.2

(51) Int. Cl. C01C 1/04

(52) U.S. Cl. CPC C01C 1/0447; C01C 1/0482

(57) ABSTRACT

The invention proposes a process for producing ammonia in which an ammonia synthesis gas is subjected to a compression and is sent to a partial conversion in an ammonia synthesis reactor, wherein a gas mixture containing unconverted components of the ammonia synthesis gas is withdrawn from the ammonia synthesis reactor and is at least partly subjected to an expansion using an expansion machine, wherein the expansion machine is used to drive one or more further apparatuses that are coupled to the expansion machine. The present invention also relates to a corresponding plant.

The invention relates to a process and to a plant for producing ammonia.

### BACKGROUND

When producing ammonia on an industrial scale, a so-called ammonia synthesis gas can be used, which is understood here in particular to be a gas mixture that substantially consists of nitrogen and hydrogen and contains traces of inert gases caused by the process. This gas mixture can be compressed in a synthesis gas compressor to a high pressure of typically 100 to 250 bar and then heated to typically 350 to 500 °C.

Since ammonia synthesis gas is only partly converted to ammonia in an ammonia synthesis reactor due to the unfavorable reaction equilibrium, ammonia is condensed out of the gas mixture, which leaves the ammonia synthesis reactor as a reaction product and the remaining, unconverted ammonia synthesis gas is returned to the ammonia synthesis reactor. Details will be explained again with reference to FIG. 1 below.

In order to condense the ammonia out of the partly converted ammonia synthesis gas, said gas is cooled as far as is economically feasible. The high-temperature heat of the hot ammonia synthesis gas at the outlet of the ammonia synthesis reactor is typically used for generating steam and the subsequent temperature window for heating the ammonia synthesis gas and heating boiler feedwater. Due to the low temperature level, it is usually not economically viably possible to use the waste heat for the final step involving cooling to ambient temperature and it is therefore typically dissipated via air or water coolers.

In addition, in order to condense out a sufficient amount of ammonia and to operate the process economically, energy must be expended to generate cold in order to achieve temperatures below ambient temperature. This requires a refrigeration system that generates cold through compression, heat dissipation and subsequent expansion of a refrigerant. According to the prior art, ammonia is also often used as the refrigerant.

In conventional processes, the energy requirement and investment costs of ammonia synthesis are mainly determined by the power of the compressors used (compressors for ammonia synthesis gas and refrigerant compressors) and their drives (electric motors or turbines).

The object of the present invention is that of realizing ammonia synthesis processes of the type described more efficiently and using less energy and investment costs.

### DISCLOSURE OF THE INVENTION

This object is achieved by a process and a plant for producing ammonia having the features of the respective independent claims. Embodiments are the subject matter of the dependent claims and of the following description.

One aspect of the process proposed within the scope of the present invention consists in directing a gas mixture emerging from an ammonia synthesis reactor to an expansion machine (also referred to synonymously as an expander) and expanding it to such an extent that the resulting shaft power of the expander approximately corresponds to the shaft power of an apparatus coupled thereto, for example, but not necessarily, the refrigerant compressor, and the expander thus partly or completely drives the coupled apparatus. The coupled apparatus can generally be any machine, for example a rotating machine such as a compressor, a pump, a booster, a blower or the like, but also a generator for generating electrical current. For reasons of clarity and to avoid repetition, reference will be made hereinafter in particular to the refrigerant compressor.

A process is proposed here for the production of ammonia, in which an ammonia synthesis gas is subjected to a compression and is sent to an ammonia synthesis reactor for partial conversion.

The ammonia synthesis gas is in particular a gas mixture substantially consisting of hydrogen and nitrogen. The term “substantially” is to be understood here in particular to mean that in a claimed composition, a material stream, etc., in addition to the obligatory constituents, further constituents are permitted, provided that the essential features of the claimed composition are not significantly changed thereby. For example, an ammonia synthesis gas “substantially consisting of hydrogen and nitrogen” is suitable for the production of ammonia without secondary components or trace gases having a significant impact on the quantity or reaction. A gas mixture which “substantially” contains or consists of one or more components may in particular contain more than 95, 99, 99.9 or 99.99% of these components in total or as individual values. Conversely, a gas mixture is “substantially free” of one or more components if it contains less than 5, 1, 0.1 or 0.01% of these components in total or as individual values. The percentages can refer to mole fractions, quantity shares or volume fractions.

Within the context of the present invention, a gas mixture is withdrawn from the ammonia synthesis reactor which (substantially) contains ammonia and unconverted components of the ammonia synthesis gas and which is at least partially expanded using an expansion machine, wherein at least one further apparatus coupled to the expansion machine is driven using the expansion machine.

In embodiments of the invention, the gas mixture withdrawn from the ammonia synthesis reactor is at least partly subjected to a plurality of cooling steps, wherein the plurality of cooling steps comprise a cooling step which is carried out using a refrigerant guided in a refrigerant circuit, wherein at least a portion of the refrigerant is compressed using a refrigerant compressor, and wherein at least a portion of the drive power of the refrigerant compressor is provided using the expansion machine, in which machine at least a portion of the gas mixture removed from the ammonia synthesis reactor is expanded.

The advantages of embodiments of the present invention include the fact that a portion of the energy in the synthesis gas can be used as mechanical power, whereby less energy has to be dissipated in the form of heat in the steam generator and boiler feedwater heater. In contrast to known processes, within the scope of the present invention, less drive power (for example compressor power for the refrigerant compressor) must be externally sent (for example as electrical power or steam turbine power). In known processes, mechanical energy that is sent is largely dissipated as heat (via steam generation and heat dissipation to the environment). The conversion of mechanical energy into heat represents a considerable exergy loss. Corresponding losses can be reduced by using the present invention.

In embodiments of the present invention, mechanical shaft power is provided using the expansion machine, wherein at least a portion of the mechanical shaft power of the expansion machine is mechanically introduced into the coupled apparatus, such as the refrigerant compressor. In particular, direct or indirect mechanical coupling can therefore be made so that conversion losses can be avoided in such an embodiment.

Embodiments of the present invention may include the fact that one or more compressor stages of the refrigerant compressor (if present), possibly also all the compressor stages, is/are driven using at least some of the mechanical shaft power. The same also applies to driving all or some of the subunits of another coupled apparatus.

In general, multi-stage turbo compressors can be used within the scope of the present invention. In principle, mechanical structure of turbocompressors is known to a person skilled in the art. In a turbocompressor, the medium to be compressed is compressed by means of turbine blades arranged on a turbine wheel or directly on a shaft. A turbocompressor forms a structural unit, but in the case of a multistage turbocompressor it can have a plurality of compressor stages. A compressor stage usually comprises a turbine wheel or a corresponding arrangement of turbine blades. All of such compressor stages may be driven by a common shaft. However, it is also possible to drive the compressor stages in groups using different shafts, wherein the shafts can be connected to one another via transmissions.

An expansion machine suitable for use within the context of the present invention can in particular be a turboexpander. A turboexpander can be constructed in a similar way to a turbo compressor, but shaft power is generated by expanding a fluid.

For particularly efficient mechanical coupling, it can be provided that one or more compressor stages of the refrigerant compressor or one or more subunits of another coupled apparatus, or the coupled apparatus as a whole, and one or more expansion stages of the expansion machine are arranged on a common mechanical shaft. In this way, particularly direct, low-loss transmission of power is possible.

In embodiments of the present invention, however, it can also be provided that at least a portion of the mechanical shaft power is converted in a transmission. In this way, in particular, an advantageous speed adjustment can be carried out in order to be able to process, for example, different volume flows or amounts of process gas, i.e., of the gas mixture withdrawn from the reactor and of the refrigerant or a medium processed, in particular compressed, in another coupled apparatus.

In embodiments of the present invention, it can also be provided that at least a portion of the mechanical shaft power is converted into electrical power. This electrical power can also be used, for example, to operate an electric motor, which provides at least some of the drive power of the refrigerant compressor. Any other units such as compressors, heaters, blowers and the like can also be driven in this way.

In embodiments of the present invention, it can be provided that the mechanical shaft power of the expansion machine exceeds the drive power of the refrigerant compressor or another coupled apparatus and a portion of the mechanical shaft power of the expansion machine that exceeds the drive power of the refrigerant compressor or the other coupled apparatus is used to drive one or more units selected from one or more compressor stages of a compressor used in the compression of the ammonia synthesis gas, one or more boiler feedwater pumps and one or more gas compressors or gas compressor stages. Corresponding embodiments of the present invention can therefore make particularly advantageous use of the mechanical power generated during the expansion process.

In embodiments of the present invention, the expansion machine can be arranged in different suitable positions, such as downstream of the ammonia synthesis reactor and upstream or downstream of a cooling step of the plurality of cooling steps. Positioning depends on the practicality and feasability each time.

In embodiments of the present invention, the process can be carried out in a first process mode and a second process mode, wherein the expansion machine is bypassed in the first process mode and only switched on in the second process mode. The first process mode can be carried out in particular during commissioning (“start-up”) of a corresponding plant until there is a sufficient amount of the gas exiting the ammonia synthesis reactor.

For the sake of completeness only, it should be noted here that in embodiments of the present invention, a portion of the ammonia synthesis gas not converted in the ammonia synthesis reactor is returned to the compression process.

Ammonia synthesis can be carried out within a pressure range of 100 to 250 bar absolute pressure and/or within a temperature range of 350 to 500 °C. In particular, a modification of the Haber-Bosch process, which is known per se, can be used.

The cooling step which is carried out using the refrigerant guided in the refrigerant circuit is in particular a step involving cooling to a temperature within a temperature range of −40 to +40 °C. Ammonia can be used as the refrigerant here, wherein the refrigerant circuit can be a closed or open refrigerant circuit. An open refrigerant circuit is characterized by the fact that some of the ammonia formed during ammonia synthesis is separated, expanded, thereby evaporated, and used as a refrigerant, and the corresponding ammonia is then converted into a product. A refrigerant in a closed refrigerant circuit has no material contact with the process gas, i.e. the gas mixture to be cooled from the ammonia synthesis process.

The present invention also relates to a plant for producing ammonia, wherein the plant is designed to subject an ammonia synthesis gas to compression and to send it to a partial conversion in an ammonia synthesis reactor, to withdraw a gas mixture containing unconverted components of the ammonia synthesis gas from the ammonia synthesis reactor, to expand at least some of the gas mixture using an expansion machine, and to drive one or more apparatuses that are coupled to the expansion machine using the expansion machine. In particular, the plant can be designed to subject at least some of the gas mixture to a plurality of cooling steps, to carry out a cooling step of the plurality of cooling steps using a refrigerant guided in a refrigerant circuit, to compress at least a portion of the refrigerant using a refrigerant compressor, and to provide at least a portion of the drive power of the refrigerant compressor using the aforementioned expansion machine.

For further features and advantages of a corresponding plant and embodiments thereof, reference is expressly made to the above explanations relating to the process proposed according to the invention and its embodiments, since they apply in the same way here.

The same also applies to a plant which, according to one embodiment of the invention, is configured to carry out a process according to any embodiment of the present invention.

### BRIEF DESCRIPTION OF THE DRAWING

Embodiments of the invention will be described below purely by way of example and with reference to the accompanying drawings, in which

FIG. 1 illustrates a process for ammonia synthesis according to an embodiment not covered by the invention,

FIG. 2 illustrates a process for ammonia synthesis according to an embodiment of the present invention,

FIG. 3 illustrates partial aspects of a process for ammonia synthesis according to an embodiment of the present invention, and

FIG. 4 illustrates partial aspects of a process for ammonia synthesis according to an embodiment of the present invention.

### EMBODIMENTS OF THE INVENTION

The embodiments described below are described solely for the purpose of assisting the reader in understanding the features claimed and previously discussed. They are merely representative examples and are not intended to be considered to be exhaustive and/or limiting with respect to the features of the invention. It goes without saying that the advantages, embodiments, examples, functions, features, structures and/or other aspects described above and below are not to be considered to limit the scope of the invention as defined in the claims, or to limit equivalents to the claims, and that other embodiments may be used and changes made without departing from the scope of the claimed invention.

Different embodiments of the invention may comprise, have, consist of, or substantially consist of further expedient combinations of the described elements, components, features, parts, steps, means, etc., even if such combinations are not specifically described herein. Furthermore, the disclosure may comprise other inventions that are presently not claimed, but which may be claimed in the future, in particular when included in the scope of the independent claims.

Explanations relating to devices, apparatuses, arrangements, systems, etc. according to embodiments of the present invention may also apply to procedures, processes, methods, etc. according to the embodiments of the present invention, and vice versa. Elements, process steps, etc. that are identical, have the same effect, correspond in terms of their function, are structurally identical or have a similar structure can be indicated by identical reference signs.

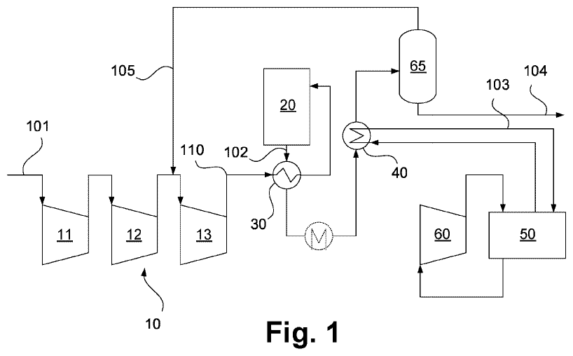

FIG. 1 illustrates a process for ammonia synthesis according to an embodiment not according to the invention in the form of a schematic diagram, to which reference was already made at the outset.

In this process, an ammonia synthesis gas 101 is subjected to a compression 10, wherein the compression 10 is carried out to the pressure mentioned at the outset and a plurality of compressor stages 11, 12 and 13 of a (turbo) compressor of the type explained can be used. At an intermediate stage, a recycle stream 105 can be fed in, which contains the mentioned components of ammonia synthesis gas as well as ammonia that has not been condensed out.

The compressed ammonia synthesis gas 101 designated by 110 is subjected to heating, fed into an ammonia synthesis reactor 20 and partly converted there. A gas mixture 102 containing unconverted components of the ammonia synthesis gas 110 is withdrawn from the ammonia synthesis reactor 20.

The gas mixture 102 is subjected to cooling 30, in particular in a feed-effluent heat exchanger against the fed-in ammonia synthesis gas 110. Several optional additional cooling steps are shown in the form of a dotted heat exchanger. A cooling step 40 is carried out using a refrigerant 103 guided in a refrigerant circuit 50, wherein at least a portion of the refrigerant 103 is compressed using a refrigerant compressor 60. In particular, the compressed refrigerant can be expanded and fed into a heat exchanger used in the cooling step 40.

Downstream of the cooling step is a liquid ammonia separation step 65, wherein unconverted ammonia synthesis gas and gaseous ammonia that has not been condensed out remain and can be returned to the compression step 10 as a material stream 105, as mentioned. Liquid ammonia can be fed to the plant boundary in the form of a product stream 104.

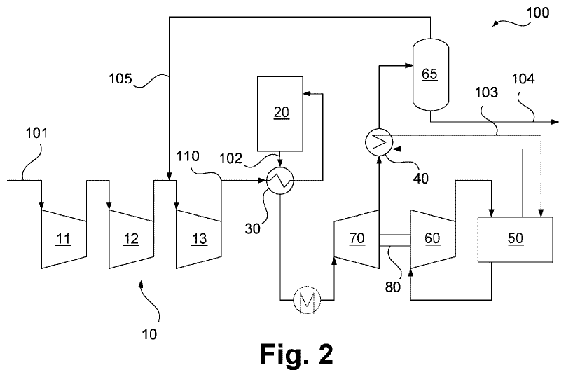

FIG. 2 illustrates a process for ammonia synthesis according to one embodiment of the present invention and is designated as a whole by 100.

Aspects of the embodiment of the invention illustrated in FIG. 2 have already been explained, and therefore the following explanations focus substantially on the differences.

As illustrated in FIG. 2, at least a portion of the drive power of the refrigerant compressor 60 is provided using an expansion machine 70, in which at least a portion of the gas mixture 102 withdrawn from the ammonia synthesis reactor 20 is expanded. As illustrated in said figure, one or more compressor stages of the refrigerant compressor 60 and one or more expansion stages of the expansion machine 70 can be arranged on a common mechanical shaft 80.

Instead of the refrigerant compressor 0, another apparatus coupled to the expansion machine 70 can also be driven, as mentioned several times, which can be the previously explained (rotating) machines or a generator for generating electrical current.

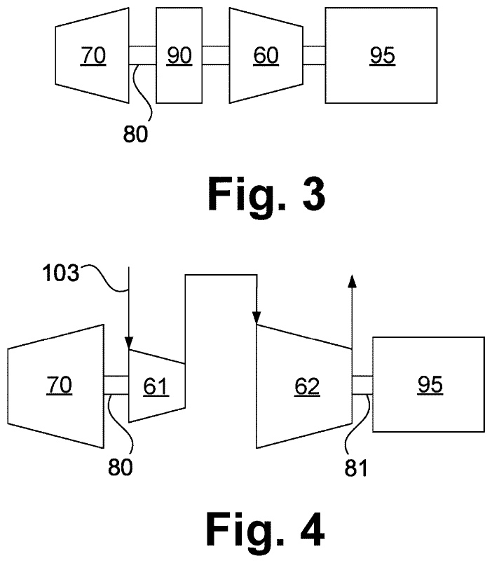

FIG. 3 illustrates partial aspects of a process for ammonia synthesis according to an embodiment of the present invention, said figure only illustrating the coupling of one or more compressor stages of the refrigerant compressor 60 and one or more expansion stages of the expansion machine 70. As shown in the figure, a transmission 90 is provided in the present case, in which at least a portion of the mechanical shaft power is converted. Furthermore, an auxiliary electric motor 95 is provided, which additionally drives the refrigerant compressor 60.

FIG. 4 illustrates further partial aspects of a process for ammonia synthesis according to a further embodiment of the present invention. Said figure shows that a compressor stage 61 of the refrigerant compressor 60 is coupled to the expansion machine 70 via a shaft 80 and a compressor stage 62, for example for higher pressure, is driven by an auxiliary electric motor 95 via a further shaft 81.

In general, whenever the above refers to driving “a compressor” by means of “an expansion machine”, this is always intended to also mean driving only some of the existing compressor stages by means of only some of the existing expander stages, without this being specifically stated.

1. A process for producing ammonia, in which an ammonia synthesis gas is subjected to a compression and is sent to a partial conversion in an ammonia synthesis reactor, wherein a gas mixture containing ammonia and unconverted components of the ammonia synthesis gas is withdrawn from the ammonia synthesis reactor, wherein the gas mixture is at least partly expanded using an expansion machine, and wherein the expansion machine is used to drive one or more further apparatuses that are coupled to the expansion machine.

2. The process according to claim 1, wherein at least a portion of the gas mixture withdrawn from the ammonia synthesis reactor is subjected to a plurality of cooling steps, wherein the plurality of cooling steps comprise a cooling step which is carried out using a refrigerant guided in a refrigerant circuit, wherein at least a portion of the refrigerant is compressed using a refrigerant compressor, wherein at least a portion of the drive power of the refrigerant compressor as the, or one of the, apparatus(es) coupled to the expansion machine is provided using the expansion machine.

3. The process according to claim 1, wherein mechanical shaft power is provided using the expansion machine, wherein at least a portion of the mechanical shaft power of the expansion machine is introduced into the apparatus or apparatuses coupled to the expansion machine.

4. The process according to claim 3, wherein one or more compressor stages of the one or more further apparatuses coupled to the expansion machine is/are driven using at least a portion of the mechanical shaft power.

5. The process according to claim 3, wherein one or more compressor stages of the one or more further apparatuses coupled to the expansion machine and one or more expansion stages of the expansion machine are arranged on a common mechanical shaft.

6. The process according to claim 3, wherein at least a portion of the mechanical shaft power is converted in a transmission.

7. The process according to claim 3, wherein at least a portion of the mechanical shaft power is converted into electrical power.

8. The process according to claim 1, wherein the mechanical shaft power the expansion machine exceeds the drive power of the one or more further apparatuses coupled to the expansion machine, and the portion of the mechanical shaft power of the expansion machine that exceeds the drive power of the refrigerant compressor is used to drive one or more units selected from one or more compressor stages of a compressor used in the compression of the ammonia synthesis gas, one or more boiler feedwater pumps, and one or more gas compressors or gas compressor stages.

9. The process according to claim 1, wherein the expansion machine is arranged downstream of the ammonia synthesis reactor and upstream or downstream of a cooling step of the plurality of cooling steps.

10. The process according to claim 1, which is carried out in a first process mode and a second process mode, wherein the expansion machine is bypassed in the first process mode and only switched on in the second process mode.

11. The process according to claim 1, wherein the portion of the ammonia synthesis gas that is not converted in the ammonia synthesis reactor is returned to the compression process.

12. The process according to claim 1, wherein ammonia synthesis is carried out at a pressure that is within a pressure range of 100 to 250 bar absolute pressure and/or at a temperature that is within a temperature range of 350 to 500 °C.

13. The process according to claim 1, wherein the cooling step carried out using the refrigerant guided in the refrigerant circuit is a step involving cooling to a temperature within a temperature range of −40 to +40 °C.

14. The process according to claim 1, wherein ammonia is used as the refrigerant, wherein the refrigerant circuit is a closed or open refrigerant circuit.

15. A plant for producing ammonia, which is designed to subject an ammonia synthesis gas to a compression and to send it to a partial conversion in an ammonia synthesis reactor, to withdraw a gas mixture containing ammonia and unconverted components of the ammonia synthesis gas from the ammonia synthesis reactor, to drive at least some of the gas mixture for expansion using an expansion machine, and to drive one or more apparatuses that are coupled to the expansion machine using the expansion machine to provide.
